(19) United States
(12) Patent Application Publication
(10) Pub. No.: US 2022/0057771 A1
(43) Pub. Date: Feb. 24, 2022

(54) MULTIDIMENSIONAL PRINT, CUT, AND CRAFT DEVICE

(71) Applicants: Philip Beffrey, Petaluma, CA (US); Jason Brinkerhoff, Santa Monica, CA (US); J. Aaron Johnson, Orem, UT (US); Rodney Stock, San Rafael, CA (US)

(72) Inventors: Philip Beffrey, Petaluma, CA (US); Jason Brinkerhoff, Santa Monica, CA (US); J. Aaron Johnson, Orem, UT (US); Rodney Stock, San Rafael, CA (US)

(21) Appl. No.: 17/405,969

(22) Filed: Aug. 18, 2021

Related U.S. Application Data
(60) Provisional application No. 63/067,162, filed on Aug. 18, 2020.

(51) Int. Cl. G05B 19/402

(52) U.S. Cl. CPC G05B 19/402; G05B 2219/37087

(57) ABSTRACT

Apparatuses, systems, and methods are disclosed for a multidimensional print, cut, and craft device. A device includes a housing, a gantry coupled to the housing, a tool housing movably coupled to the gantry, a tool holder coupled to the tool housing, and a material platform. The tool housing is movable in three dimensions in response to the gantry being actuated to craft a material placed on the material platform using a tool placed in the tool holder.

### CROSS REFERENCES TO OTHER APPLICATIONS

This application claims the benefit of U.S. Provisional Patent Application No. 63/067,162 entitled “PRINT AND CUT DEVICE” and filed on Aug. 18, 2020, for Aaron Johnson et al., which is incorporated herein by reference.

### FIELD

This invention relates to crafting devices and more particularly relates to a multidimensional print, cut, and craft device.

### BACKGROUND

Crafting devices are used to create arts and crafts. Some crafting devices may include printing and cutting means for printing predefined designs on a material or cutting a material into a predefined design.

### BRIEF SUMMARY

Apparatuses, systems, and methods are disclosed for a multidimensional print, cut, and craft device. A device, in one embodiment, includes a housing, a gantry coupled to the housing, a tool housing movably coupled to the gantry, a tool holder coupled to the tool housing, and a material platform. The tool housing, in one embodiment, is movable in three dimensions in response to the gantry being actuated to craft a material placed on the material platform using a tool placed in the tool holder.

A system, in one embodiment, includes a device that includes a housing, a gantry coupled to the housing, a tool housing movably coupled to the gantry, a tool holder coupled to the tool housing, and a material platform. The tool housing, in one embodiment, is movable in three dimensions in response to the gantry being actuated to craft a material placed on the material platform using a tool placed in the tool holder.

The system, in one embodiment, further includes an apparatus that includes a processor and a memory that stores code executable by the processor to receive predefined instructions for crafting the material using at least one tool within the tool holder, move the tool housing on the gantry according to the predefined instructions, the gantry configured to move in two-dimensions within a horizontal plane and along a vertical axis within a vertical plane, and apply a craft to the material according to the predefined instructions using the at least one tool within the tool housing.

An apparatus, in one embodiment, includes means for receiving predefined instructions for crafting the material using at least one tool within the tool holder, moving the tool housing on the gantry according to the predefined instructions, the gantry configured to move in two-dimensions within a horizontal plane and along a vertical axis within a vertical plane, and applying a craft to the material according to the predefined instructions using the at least one tool within the tool housing.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a perspective view illustrating one embodiment of a multidimensional print, cut, and craft device as described herein;

FIG. 1B is a perspective view illustrating another embodiment of a multidimensional print, cut, and craft device as described herein;

FIG. 2A is a perspective view illustrating one embodiment of a tool holder for a multidimensional print, cut, and craft device as described herein;

FIG. 2B is a perspective view illustrating another embodiment of a tool holder for a multidimensional print, cut, and craft device as described herein;

FIG. 2C is a perspective view illustrating another embodiment of a tool holder for a multidimensional print, cut, and craft device as described herein;

FIG. 2D is a perspective view illustrating another embodiment of a tool holder for a multidimensional print, cut, and craft device as described herein;

FIG. 3A is a perspective view illustrating one embodiment of a tool holder for a multidimensional print, cut, and craft device as described herein;

FIG. 3B is a perspective view illustrating another embodiment of a tool holder for a multidimensional print, cut, and craft device as described herein;

FIG. 3C is a perspective view illustrating another embodiment of a tool holder for a multidimensional print, cut, and craft device as described herein;

FIG. 4A is a perspective view illustrating one embodiment of a material deck for a multidimensional print, cut, and craft device as described herein;

FIG. 4B is a perspective view illustrating another embodiment of a material deck for a multidimensional print, cut, and craft device as described herein;

FIG. 4C is a perspective view illustrating another embodiment of a material deck for a multidimensional print, cut, and craft device as described herein;

FIG. 4D is a perspective view illustrating another embodiment of a material deck for a multidimensional print, cut, and craft device as described herein.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to emphasize their implementation independence more particularly. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Apparatuses, systems, and methods are disclosed for a multidimensional print, cut, and craft device. A device, in one embodiment, includes a housing, a gantry coupled to the housing, a tool housing movably coupled to the gantry, a tool holder coupled to the tool housing, and a material platform. The tool housing, in one embodiment, is movable in three dimensions in response to the gantry being actuated to craft a material placed on the material platform using a tool placed in the tool holder.

In one embodiment, the gantry is configured to move in two-dimensions within a horizontal plane and along a vertical axis within a vertical plane. In one embodiment, the tool placed in the tool holder comprises one or more of a print tool for printing on the material and a cut tool for cutting the material.

In one embodiment, the tool holder is orientable at an angle that is greater than 0° and less than 90°. In one embodiment, the tool holder is rotatable about a radial axis, the tool holder comprising a magnet coupled to the tool holder that corresponds to a magnet within one of the housing and the deck such that the tool holder is rotated in response to one of an attraction and a repulsion by the magnets.

In one embodiment, the apparatus further includes a power source for providing power to one or more of the tool housing, the tool holder, and a tool placed in the tool holder. In one embodiment, the tool holder further comprises electrical contact points that correspond to electrical contact points on a tool placed in the tool holder to provide power to the tool.

In one embodiment, the material platform is coupled to an actuator that is configured to move the material platform in at least one of a horizontal, vertical, and radial direction. In one embodiment, the material platform further comprises means for securing the material on the material platform while the material is being printed and/or cut.

A system, in one embodiment, includes a device that includes a housing, a gantry coupled to the housing, a tool housing movably coupled to the gantry, a tool holder coupled to the tool housing, and a material platform. The tool housing, in one embodiment, is movable in three dimensions in response to the gantry being actuated to craft a material placed on the material platform using a tool placed in the tool holder.

The system, in one embodiment, further includes an apparatus that includes a processor and a memory that stores code executable by the processor to receive predefined instructions for crafting the material using at least one tool within the tool holder, move the tool housing on the gantry according to the predefined instructions, the gantry configured to move in two-dimensions within a horizontal plane and along a vertical axis within a vertical plane, and apply a craft to the material according to the predefined instructions using the at least one tool within the tool housing.

In one embodiment, the predefined instructions comprise a force parameter that defines an amount of pressure for a tool to apply to the material during the craft. In one embodiment, the code is executable by the processor to encode information on the material that is not received in the predefined instructions.

In one embodiment, the encoded information comprises at least one of a starting position, an ending position, a project name, and a date for a craft project. In one embodiment, the code is executable by the processor to receive instructions provided as voice commands for controlling at least one of movement of the tool housing, an amount of force applied to the material by a tool in the tool holder, and application of a tool to the material.

In one embodiment, the code is executable by the processor to craft steganographic information on the material. In one embodiment, the code is executable by the processor to convert an image that is received for crafting into a series of instructions for crafting the image on the material.

In one embodiment, the code is executable by the processor to determine whether the image comprises proprietary information and provide recommendations for alternative images. In one embodiment, the code is executable by the processor to determine an amount of electromotive force (“EMF”) that is being used for crafting, the EMF used to determine characteristics of a type of material being used, a sharpness of a printing tool, and a sharpness of a blade of a tool that is used to cut the material. In one embodiment, the code is executable by the processor to identify unused portions of the material that can be used to craft a design according to the received instructions.

An apparatus, in one embodiment, includes means for receiving predefined instructions for crafting the material using at least one tool within the tool holder, moving the tool housing on the gantry according to the predefined instructions, the gantry configured to move in two-dimensions within a horizontal plane and along a vertical axis within a vertical plane, and applying a craft to the material according to the predefined instructions using the at least one tool within the tool housing.

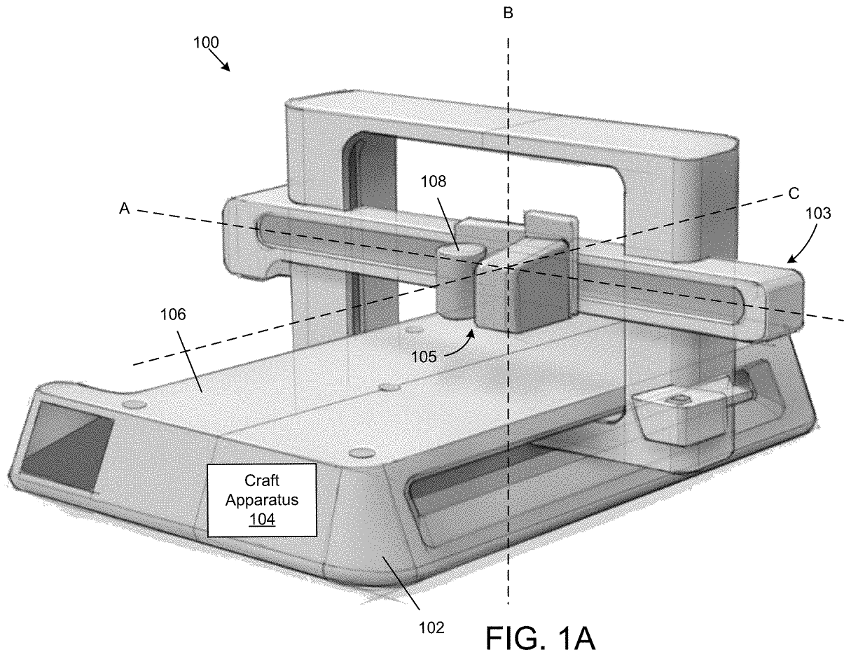

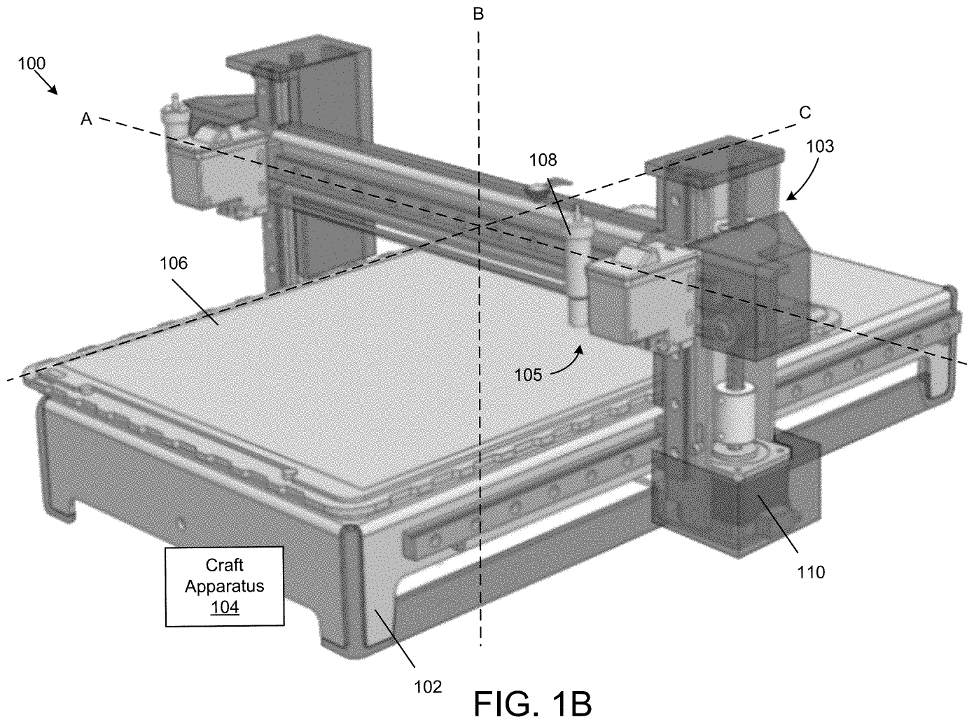

FIG. 1A is a perspective view illustrating one embodiment of a multidimensional print, cut, and craft device as described herein. In one embodiment, a crafting device 100 includes a housing 102, a gantry 103, a craft apparatus 104, a tool housing 105, and a deck or platform 106, which are described in more detail below.

In general, the multidimensional print, cut, and craft device is used to produce, apply, generate, make, or the like crafts. As used herein, crafting may refer to generating a design on a material such as printing on material, cutting material, and/or applying other effects to various materials such as paper, wood, cardboard, food, metal, plastic, and/or the like, as described below.

The crafting device 100 may include a housing 102 for housing various mechanical components of the crafting device 100, e.g., gears and motors for actuating the tool housing 105 along the gantry 103; controllers, processors, memories, or the like for controlling movement of the gantry and actuation of tools within the tool housing 105; and/or the like.

Even though a particular design of a crafting device 100 is shown in FIG. 1A, various designs may be used such as an open-top housing, a closed-top housing, a housing with open or closed sides, a housing with legs, a housing with a lid or cover, and/or the like.

In one embodiment, the gantry 103 is configured to allow the tool housing 105 to slide or move within a horizontal plane along an axis A and an axis C in a side-to-side direction, e.g., horizontal direction to allow printing and cutting of a material on the deck/platform 106 in a two-dimensional plane, e.g., an x-y plane.

In further embodiments, the gantry 103 is configured to move along a vertical axis B, which is perpendicular to axes A and C, e.g., in an up-down direction or vertical direction to allow printing and cutting of a material on the deck/platform 106 in a third-dimensional plane, e.g., a z-plane. In such an embodiment, adding a third dimension to the tool housing 105 allows tools such as print and cut heads within the tool housing 105 to apply force or pressure effects to the printing and/or cutting of material placed on the deck 106.

For example, if a brush head is placed in the tool housing 105 for printing a color on a material such as paper, moving the gantry in the z-direction, e.g., along the vertical axis B, may allow the tool housing 105 to apply lighter brush strokes as the tool housing 105 is moved away from the paper and heavy brush strokes as the tool housing 105 is moved closer to the paper. Similarly, different cutting effects may be produced by moving the tool housing 105 towards and away, e.g., along the z-plane, from the material on the deck/platform 106.

The tool housing 105 may include a tool holder 108 that is configured to hold different types of crafting tools such as print and cut tools. The tools may be inserted into the tool holder 108, which may include predefined slot in the tool housing 105 and may snap in, e.g., with a snap fit or with a magnetic force, or otherwise be secured within the tool housing 105. Examples of print tools may include tools such as paint brushes, crayons, stamps, markers, highlighters, pens, pencils, charcoal, chalk, and/or the like. Examples of cut tools may include knives, razors, hole punches, pins, and/or the like. Other tools may be used such as laser tools (e.g., for laser etching), three-dimensional printing tools, extrusion tools for extruding material (e.g., for extruding food-based material), wood burning tools, carving tools, drilling tools, and/or the like. The tool housing 105 may be configured to hold multiple different tools, both print and/or cut tools, and may be in communication with a controller to control tools, to select tools (e.g., from a tool repository), and/or the like.

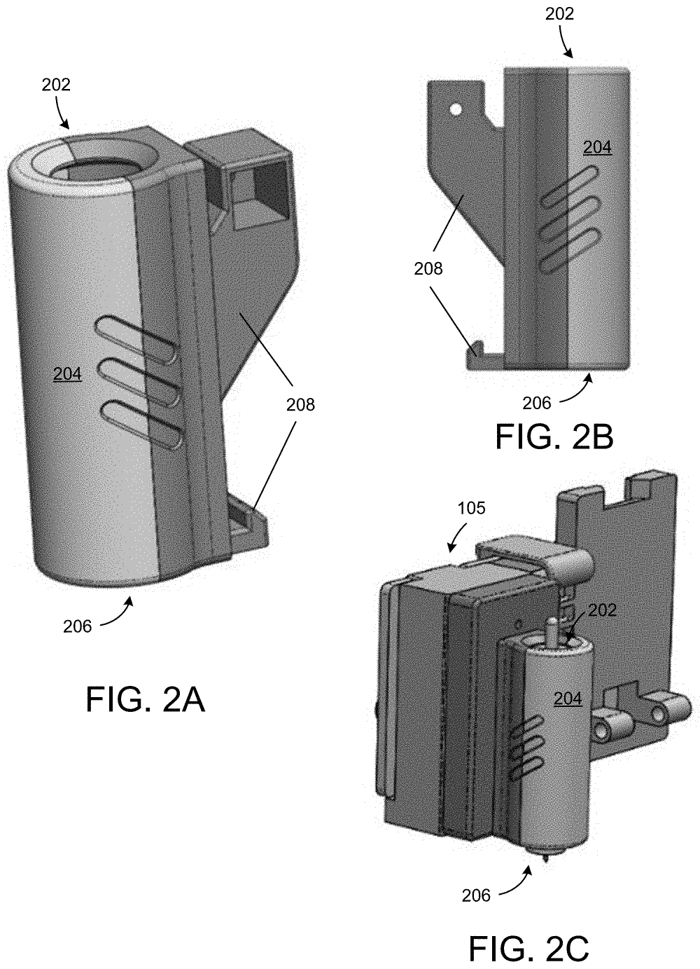

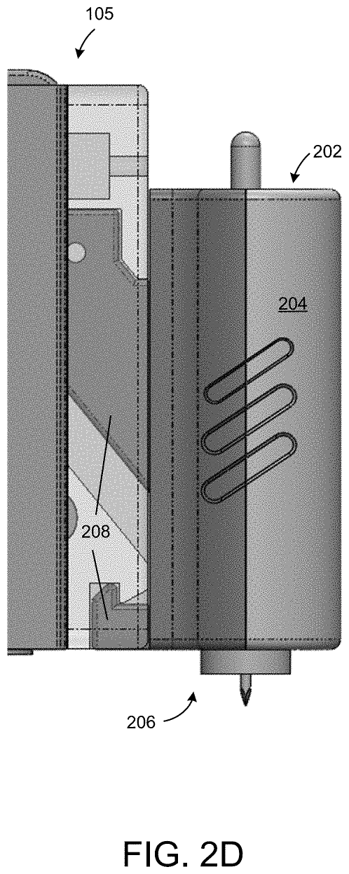

FIGS. 2A-2D depict examples of an embodiment of a tool holder 108. In the depicted embodiments, the tool holder 108 includes an opening 202 for receiving a tool and a shaft/body 204 for securing the tool within the tool holder. The tool holder 108 may include an opening 206 and the base of the body 204 where the point or usable portion of the tool protrudes. The tool holder 108 may be permanently affixed to the tool housing 105 (e.g., molded together as one piece), or may be selectively coupled to the tool housing 105 such that different tool holders 108 can be coupled to the tool housing 105. The tool holder 108 may be selectively coupled to the tool housing 105 using attachment 208, which may include protruding tabs, clips, snaps, or the like that match with corresponding portions on the tool housing 105, as shown in FIG. 2D.

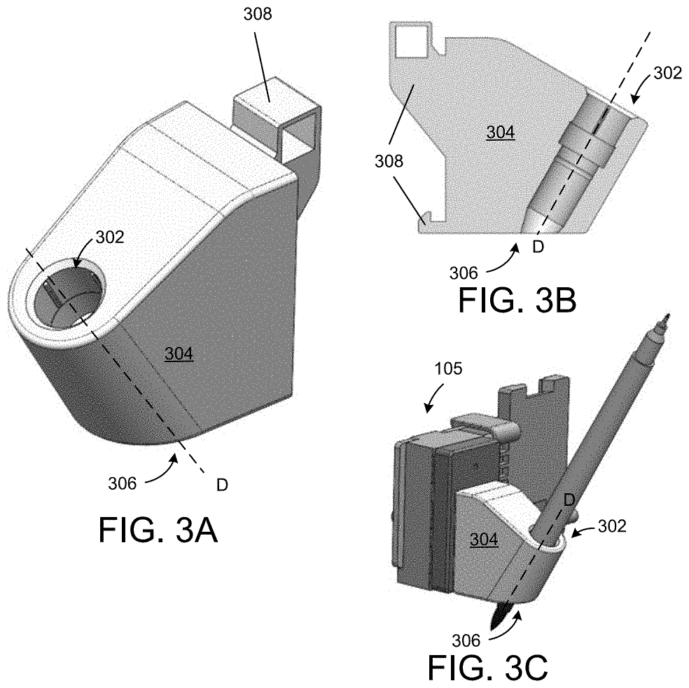

The tool holder 108 may be oriented in a substantially vertical position, e.g., along a vertical axis or plane and perpendicular to a horizontal axis or plane, as shown in FIGS. 2A-2D. In further embodiments, however, the tool holder 108 may be oriented at an angle between horizontal and vertical, e.g., at an angle between 0° and 90°, as shown in FIGS. 3A-3C. FIGS. 3A-3C depict an embodiment of another tool holder 108 that includes an opening 302 for receiving a tool, a body 304, an opening 306 for exposing a point, tip, or usable portion of the tool, and attachment means 308 for attaching the tool holder 108 to the tool housing 105. In one embodiment, the tool holder 108 is set at a fixed angle, e.g., 30°, which allows tools that are inserted into the tool holder 108 to be used for angular prints, cuts, and/or the like.

In certain embodiments, however, the tool holder 108 or the body 304 of the tool holder 108, may be coupled to a hinge or other means and an actuator for selectively angling the tool holder 108 at varying degrees. In such an embodiment, the angle of the tool holder 108 may be controllable via a controller or craft apparatus 104, described below, or may manually be set, adjusted, moved, positioned, or the like. In this manner, the tools can be placed at different angles to provide different strokes, cuts, and/or the like.

Referring to FIGS. 2A-3C, in one embodiment, the tool holder 108 is rotatable about a radial axis, or the tool within the tool holder 108 is rotatable about the radial axis, which allows the tool to be rotated to a position to start a print/cut, while printing/cutting, or the like. In one embodiment, the tool holder 108 or tool is rotatable using at least a pair of magnets, one located on the tool holder 108 or tool and another located on a side of the housing 102 and/or the deck 106.

For instance, one issue with cutting material may be making cuts at sharp angles or corners because the blade of the cutting tool is embedded in the material, which may produce a rounded corner or an angled corner instead of a sharp, square corner. Thus, in one embodiment, the craft apparatus 104 may be configured to control the tool housing 105 to cut segments at a time, where a segment comprises a curve that starts at a sharp angle and ends at a sharp angle (e.g., a 90 degree angle). For example, a square would include four different segments and therefore four different cuts where the cutting tool is removed from the material at each corner, rotated, and placed into the material again to cut the next segment.

In one embodiment, the tool, tool holder 108, blade, or the like is rotatable/oriented by using a pair of magnets, where one magnet is located on the tool holder 108 and another magnet is located on the deck 106 or housing 102. To orient the tool/blade for each cut (at a sharp angle), the craft apparatus 104 could actuate a motor to drive the tool housing 105 to the magnet in the deck 106 and place it at an angle relative to the magnet in the deck 106 such that the attraction (or repulsion) between the magnet on the tool holder and the magnet in the deck causes the tool holder 108, or the tool within the tool holder 108, to rotate/orient to a determined or calculated position.

In certain embodiments, the tool housing 105 may include and/or be connected to a power source (e.g., shore power, battery power, solar power, and/or the like) to enable, trigger, activate or the like certain tools requiring power such as hot glue tools (e.g., for enabling the heater for the glue gun), heaters, fans, metallic tools, electric knives/cutters, wood burners, hole punches, 3D printing tools, lasers, foil applicators, soldering tools, orbital tools (e.g., Dremel® tools), extrusion tools, drilling tools, and/or the like. Tools that use power may have electronic contact points/pins that interface with corresponding electronic contact points/pins in the tool holder 108 such that when the tool snaps into the tool holder 108 and the contact points/pins make contact, power is provided to the tool.

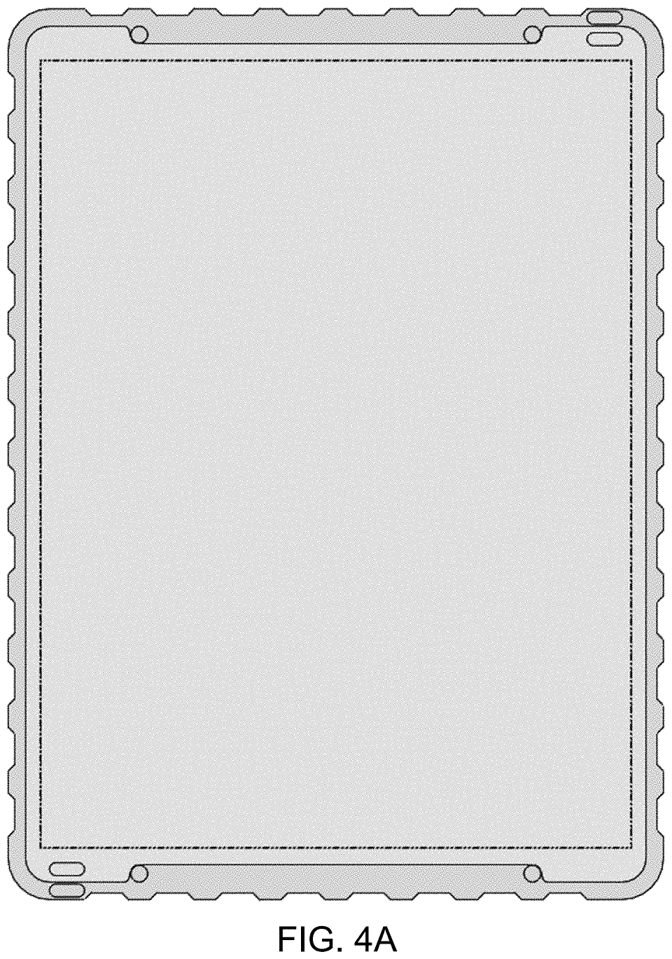

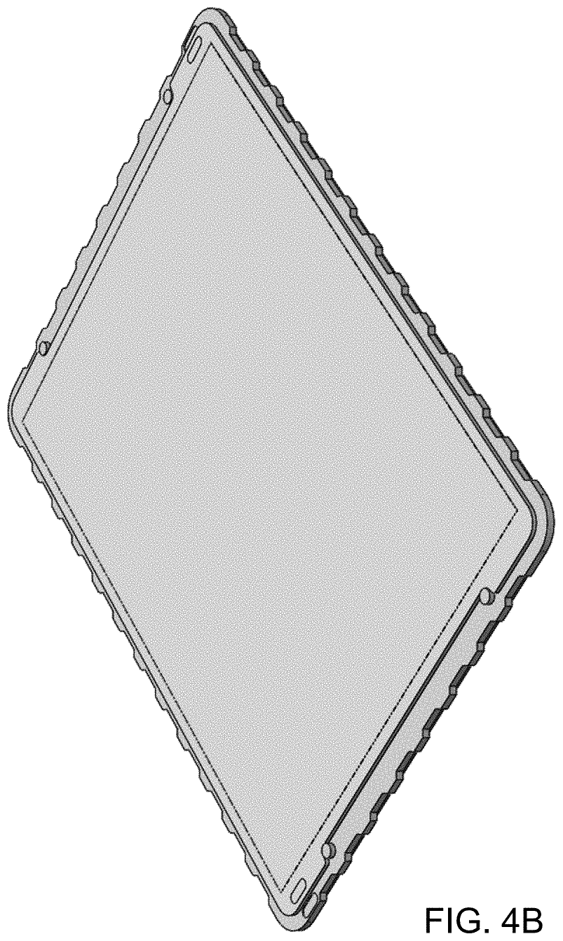

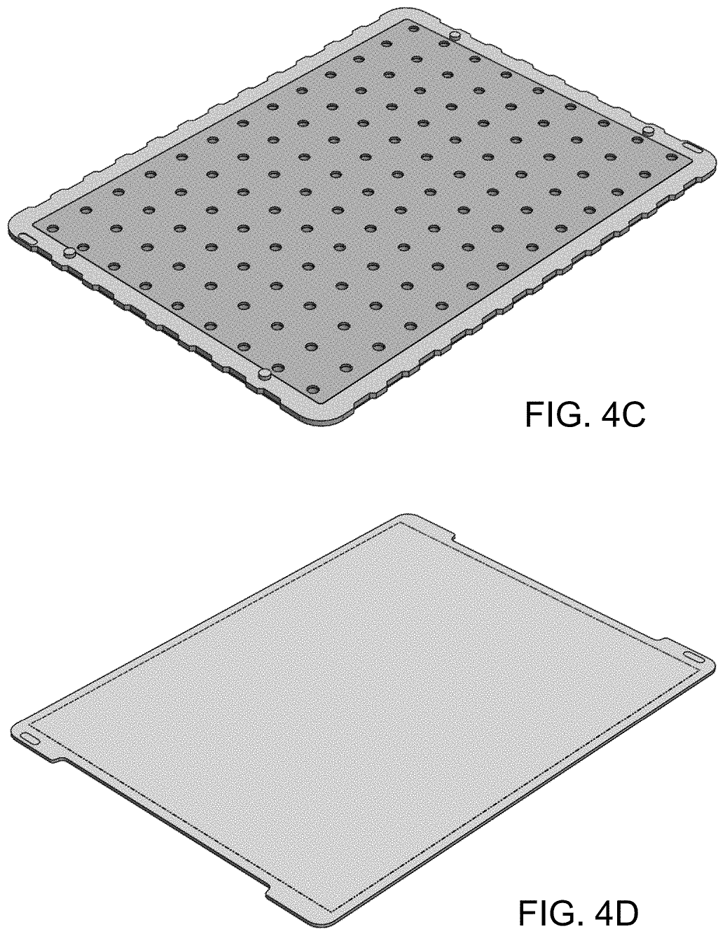

In one embodiment, the platform/deck 106, as shown in FIGS. 4A-4D, is configured for placing material such as paper, canvas, vinyl, books, wood, metal sheets, and/or the like while the crafting device 100 prints and/or cuts on the material. In such an embodiment, the clearance between the tool housing 105 and the platform/deck 106 may be adjustable along an axis B to accommodate materials of different heights. In such an embodiment, the clearance along the axis B may be dynamically adjusted (e.g., automatically using sensors, cameras, and/or the like) to account for different thickness in the material, e.g., if the surface of the material has different projections, bumps, dips, grooves, and/or the like. The platform/deck 106 may include means for securing the material to the platform/deck 106 such as by suction, e.g., a vacuum, clips, clamps, pins, adhesives, magnets, a non-slip surface, and/or the like.

In some embodiments, the platform/deck 106 is configured to rotate, move side-to-side (along axes A and C), move up/down (along axis B), and/or the like. In certain embodiments, the platform/deck 106 is configured to feed material through the housing 102, e.g., using rollers, rails, belts, and/or the like, while the crafting device 100 is in use, e.g., from the platform/deck 106 through the housing 102 and out the rear surface of the housing 102.

In one embodiment, the platform/deck 106, and/or the material on the deck 106, may include a cold or frozen surface that can be used to create cold-based crafts, e.g., extruding food-based materials onto the surface, onto other food that is placed on the deck, e.g., a cake or ice cream, and/or the like. Thus, the platform/deck 106, as shown in FIGS. 4A-4D may include interchangeable surfaces based on the type of craft being produced.

In certain embodiments, the craft apparatus 104 may include a hardware device such as a secure hardware dongle or other hardware appliance device (e.g., a set-top box, a network appliance, or the like) that attaches to a device such as a laptop computer, a crafting device 100, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NEC”), or the like); that attaches to an electronic display device (e.g., a television or monitor using an HDMI port, a DisplayPort port, a Mini DisplayPort port, VGA port, DVI port, or the like); and/or the like.

A hardware appliance of the craft apparatus 104 may include a power interface, a wired and/or wireless network interface, a graphical interface that attaches to a display, and/or a semiconductor integrated circuit device as described below, configured to perform the functions described herein with regard to the craft apparatus 104.

The craft apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like.

In one embodiment, the craft apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the craft apparatus 104.

The semiconductor integrated circuit device or other hardware appliance of the craft apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the craft apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The craft apparatus 104, in one embodiment, is configured to control the tool housing 105 to print and/or cut different designs, schematics, drawings, figures, and/or the like onto material that is placed on the deck 106. The craft apparatus 104 may receive instructions input directly into the crafting device 100, from an external device that is communicatively coupled to the crafting device 100, over a network connection (e.g., a wired or wireless network connection), and/or the like for controlling the tool housing 105.

For instance, the instructions may include commands, instructions, directions, or the like for moving the tool housing along the axes A and C and/or along the axis B and/or for activating tools within the tool holder 108, e.g., a print tool, a cut tool, a power tool, and/or the like. In certain embodiments, if the tool housing 105 comprises multiple tool holders 108 holding tools, the tools within the tool holders, e.g., a print tool and a cut tool, may be activated simultaneously or may work independently of one another.

The instructions may be in a data format that includes directions for moving the tool housing 105 along the gantry 103 e.g., along the axes A and C in a two-dimensional direction and also along the axis B in a three-dimensional direction. In other words, the data format includes an additional variable, value, parameter, or the like for moving the tool housing 105 in the z-plane. The third parameter may include a force or pressure value indicating how much force or pressure to apply for the tool within the tool holder 108. The data format may include raster data, scalable vector graphics (“SVG”) data, and/or the like and/or any combination of the foregoing.

Thus, the data format may include image data in the form of raster and/or SVG data and also a pressure or force variable/parameter. The force parameter may include a single force value or a scale of force values for applying a gradual amount of force, e.g., going from a light brush stroke to a heavier brush stroke or vice versa. In one embodiment, the data format may include an audio field for adding audio, e.g., a file or recording, into the data, e.g., embedded, attached, or otherwise contained within the data as a layer.

In certain embodiments, the craft apparatus 104 receives and interprets voice commands to control movement of the tool housing 105, to control usage of the tools, e.g., print and/or cut tools, and/or the like. The voice commands may include words/directions such as “move left,” “apply more force,” “reduce brush stroke size,” and/or the like.

In one embodiment, the craft apparatus 104 is configured to encode information on the material on the platform/deck 106 before, during, and/or after any actions performed on the material, e.g., printing and/or cutting actions. For instance, the craft apparatus 104 may encode a date, a project name, a name, and/or the like on the material. In some embodiments, the craft apparatus 104 may encode action information, e.g., print and/or cut information such as a starting point of the action, an ending point of the action, the last instruction performed, and/or the like so that actions such as printing and cutting may be stopped and started again at a later time.

In certain embodiments, the craft apparatus 104 is configured to perform steganography operations to embed or encode, e.g., print and/or cut, information into the material that is not noticeable or visible to a human, but may be read, analyzed, interpreted, and/or the like by a machine, device, computer, and/or the like. Examples may include hidden or imperceivable codes (e.g., QR codes, bar codes, or the like), watermarks, images, text, markings, and/or the like.

In one embodiment, the craft apparatus 104 is configured to perform shape recognition, structure recognition, image recognition, and/or the like, for objects printed, embossed, or the like on the material that is inserted into the crafting device 100. Once recognized or identified, the craft apparatus 104 may check a database, data store, or the like to determine if the image is known, recognized, copyrighted, licensed, branded, trademarked, and/or the like.

For example, if a user prints and/or cuts an image of Mickey Mouse that they took a photo of and sent to the crafting device 100, the craft apparatus 104 may identify or recognize the image and interface with a database, e.g., locally or over a data network, to check (e.g., perform an image search) whether the image is potentially “owned” by someone else, e.g., licensed, assigned, or the like. In response to a positive result, the craft apparatus 104 may notify or alert the user, e.g., via an interface, push notification, or the like that the image is potentially owned by another party and may suggest alternative images that are similar to the image the user is printing or cutting (e.g., free images, unlicensed images, open source images, or and/the like).

In one embodiment, the craft apparatus 104 is configured to print different layers on the material. For instance, the craft apparatus 104 may apply a white layer on the material prior to printing other layers over the white layer.

In one embodiment, the craft apparatus 104 is configured to determine whether a material that is placed on the platform/deck 106 is a proprietary material or a different material. Proprietary material may include material that is licensed or authorized to be used in the crafting device 100. The material may include information encoded on the material, e.g., a bar code, a QR code, and/or the like that is read by a camera, scanner, and/or other sensor when the material is placed on the platform/deck 106. The craft apparatus 104 may cross-reference the information with a list of authorized/licensed materials that can be used in the crafting device 100. If there is no information encoded on the material, or the material information is not included on the predefined list of authorized materials, the craft apparatus 104 may not allow the crafting device 100 to be used. In further embodiments, if a proprietary material is used, the craft apparatus 104 may credit a user account with points, rewards, coupons, offers, and/or the like.

In one embodiment, the craft apparatus 104 identifies unused portions, areas, or the like of a material that is placed in the crafting device 100 and determines whether an image that the user would like to print and/or cut “fits” within the unused area, e.g., has dimensions that match the dimensions of the unused area. In this manner, material space can be maximized/conserved while minimizing waste by allowing material that has been cut in certain areas, but not others, to be completely used.

In certain embodiments, the tools in the tool holder 108 may include post-use tools such as glitter tools, varnish tools, sheen tools, and/or the like for applying post-use effects. In such an embodiment, the craft apparatus 104 may be configured to direct the tools in the tool housing 104 to apply post-use effects, e.g., after-print/after-cut applications to the material such as glitter, sheen spray, varnish, and/or the like.

In one embodiment, the craft apparatus 104 reads, receives, determines, or the like data that describes an amount of electromotive force (“EMF”) that is being output by at least one motor that is driving a print or cut tool while it prints or cuts. The EMF data can be fed into a machine learning model and/or an artificial intelligence algorithm to monitor, determine, calculate, or the load on the at least one motor and predict, estimate, or the like the type of material that is being used, e.g., cut, the thickness/depth of the material, the density of the material, the sharpness of a cutting blade, an amount remaining of a tip of a printing tool, and/or the like. In such an embodiment, the craft apparatus 104 may generate recommendations, based on the machine learning, such as recommendations for changing the blade of a cutting tool. Other settings may be automatically set or determined based on the machine learning, such as cut or print settings for specific types of materials, which may be automatically detected and determined using the machine learning based on the EMF data.

FIG. 1B is a perspective view illustrating another embodiment of a multidimensional print, cut, and craft device as described herein, which may be substantially similar to the multidimensional print, cut, and craft device described above with reference to FIG. 1A. The multidimensional print, cut, and craft device 100 depicted in FIG. 1B provides a transparent view to expose gearing, motors, actuators, and/or the like (collectively 110) that are used to control the gantry 103, the tool housing 105, the tool holder 108, and/or the like.

FIGS. 2A-2D depict various perspective views of one embodiment of a tool holder 108, as described in detail above.

FIGS. 3A-3C depict various perspective views of another embodiment of a tool holder 108, as described in detail above.

FIGS. 4A-4D depict various perspective views of one embodiment of a deck or platform 106, as described in detail above.

A means for receiving predefined instructions, in various embodiments, may include a craft apparatus 104, a processor, an FPGA, an ASIC, a computing device, other logic hardware, and/or other executable code stored on a computer readable storage medium. Other embodiments may include similar or equivalent means for receiving predefined instructions.

A means for moving the tool housing on a gantry according to the predefined instructions, in various embodiments, may include a craft apparatus 104, a processor, an FPGA, an ASIC, a computing device, other logic hardware, and/or other executable code stored on a computer readable storage medium, a motor, an actuator, and/or the like. Other embodiments may include similar or equivalent means for moving the tool housing on a gantry according to the predefined instructions.

A means for applying a craft to the material according to the predefined instructions, in various embodiments, may include a craft apparatus 104, a processor, an FPGA, an ASIC, a computing device, other logic hardware, and/or other executable code stored on a computer readable storage medium, an actuator, a motor, a tool, a tool housing, a gantry, and/or the like. Other embodiments may include similar or equivalent means for applying a craft to the material according to the predefined instructions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device, comprising:
a housing;
a gantry coupled to the housing;
a tool housing movably coupled to the gantry;
a tool holder coupled to the tool housing; and
a material platform,
wherein the tool housing is movable in three dimensions in response to the gantry being actuated to craft a material placed on the material platform using a tool placed in the tool holder.

2. The device of claim 1, wherein the gantry is configured to move in two-dimensions within a horizontal plane and along a vertical axis within a vertical plane.

3. The device of claim 1, wherein the tool placed in the tool holder comprises one or more of a print tool for printing on the material and a cut tool for cutting the material.

4. The device of claim 1, wherein the tool holder is orientable at an angle that is greater than 0° and less than 90°.

5. The device of claim 1, wherein the tool holder is rotatable about a radial axis, the tool holder comprising a magnet coupled to the tool holder that corresponds to a magnet within one of the housing and the deck such that the tool holder is rotated in response to one of an attraction and a repulsion by the magnets.

6. The device of claim 1, further comprising a power source for providing power to one or more of the tool housing, the tool holder, and a tool placed in the tool holder.

7. The device of claim 1, wherein the tool holder further comprises electrical contact points that correspond to electrical contact points on a tool placed in the tool holder to provide power to the tool.

8. The device of claim 1, wherein the material platform is coupled to an actuator that is configured to move the material platform in at least one of a horizontal, vertical, and radial direction.

9. The device of claim 1, wherein the material platform further comprises means for securing the material on the material platform while the material is being printed and/or cut.

10. A system, comprising:
a device, comprising:
a housing;
a gantry coupled to the housing;
a tool housing movably coupled to the gantry;
a tool holder coupled to the tool housing; and
a material platform,
wherein the tool housing is movable in three dimensions in response to the gantry being actuated to craft a material placed on the material platform using a tool placed in the tool holder; and
an apparatus, comprising:
a processor and a memory that stores code executable by the processor to:
receive predefined instructions for crafting the material using at least one tool within the tool holder;
move the tool housing on the gantry according to the predefined instructions, the gantry configured to move in two-dimensions within a horizontal plane and along a vertical axis within a vertical plane; and
apply a craft to the material according to the predefined instructions using the at least one tool within the tool housing.

11. The system of claim 10, wherein the predefined instructions comprise a force parameter that defines an amount of pressure for a tool to apply to the material during the craft.

12. The system of claim 10, wherein the code is executable by the processor to encode information on the material that is not received in the predefined instructions.

13. The system of claim 12, wherein the encoded information comprises at least one of a starting position, an ending position, a project name, and a date for a craft project.

14. The system of claim 10, wherein the code is executable by the processor to receive instructions provided as voice commands for controlling at least one of movement of the tool housing, an amount of force applied to the material by a tool in the tool holder, and application of a tool to the material.

15. The system of claim 10, wherein the code is executable by the processor to craft steganographic information on the material.

16. The system of claim 10, wherein the code is executable by the processor to convert an image that is received for crafting into a series of instructions for crafting the image on the material.

17. The system of claim 16, wherein the code is executable by the processor to determine whether the image comprises proprietary information and provide recommendations for alternative images.

18. The system of claim 10, wherein the code is executable by the processor to determine an amount of electromotive force (“EMF”) that is being used for crafting, the EMF used to determine characteristics of a type of material being used, a sharpness of a printing tool, and a sharpness of a blade of a tool that is used to cut the material.

19. The system of claim 10, wherein the code is executable by the processor to identify unused portions of the material that can be used to craft a design according to the received instructions.

20. An apparatus, comprising:
means for receiving predefined instructions for crafting the material using at least one tool within the tool holder;
means for moving the tool housing on the gantry according to the predefined instructions, the gantry configured to move in two-dimensions within a horizontal plane and along a vertical axis within a vertical plane; and
means for applying a craft to the material according to the predefined instructions using the at least one tool within the tool housing.
